(19) United States
(12) Patent Application Publication
(10) Pub. No.: US 2019/0228062 A1
(43) Pub. Date: Jul. 25, 2019

(54) METHOD, APPARATUS, AND SERVER FOR RENDERING A CELL PAGE, AND READABLE STORAGE MEDIUM

(71) Applicant: Ping An Technology (Shenzhen) Co., Ltd., Shenzhen, Guangdong (CN)

(72) Inventors: Qinglin Wu, Shenzhen, Guangdong (CN); Jinping Liu, Shenzhen, Guangdong (CN); Jianhu Huang, Shenzhen, Guangdong (CN); Chao Wang, Shenzhen, Guangdong (CN)

(21) Appl. No.: 16/317,030

(22) PCT Filed: Feb. 10, 2018
(86) PCT No.: PCT/CN2018/076155

§ 371 Date: Jan. 10, 2019

(30) Foreign Application Priority Data
May 5, 2017 (CN) 201710315372.7

(51) Int. Cl. G06F 17/24; G06F 3/0481; G06F 3/0482

(52) U.S. Cl. CPC G06F 17/246; G06F 17/245; G06F 3/0482; G06F 17/243; G06F 3/04812

(57) ABSTRACT

Disclosed is a method for rendering a cell page, the method including: obtaining, by a server, a preset editor and a worksheet to be processed, where the worksheet includes multiple cells; in response to detection of a click event at the location of any one of the multiple cells, obtaining a table attribute of the cell based on the editor; and initializing a worksheet element for the cell based on the obtained table attribute, to realize the rendering of the cell page, where the worksheet includes a text entry box, a drop-down box, a selection box, or a date selection box. Further disclosed are an apparatus and a server for rendering a cell page, as well as a readable storage medium.

The present application claims priority to China Patent Application No. 201710315372.7, filed May 5, 2017 with the State Intellectual Property Office and entitled “Method and Server for Rendering a Cell page, and Computer-Readable Storage Medium”, the entirety of which is hereby incorporated herein by reference.

### TECHNICAL FIELD

The present disclosure generally relates to the technical field of data table processing, and more particularly relates to a method, an apparatus, and a server for rendering a cell page, as well as a readable storage medium.

### BACKGROUND

In conventional data entry, a browser renders a worksheet page in a front-end interface, namely renders the worksheet elements of each and every cell in the front-end interface. To render the worksheet elements of the cells, the browser needs to bind each cell to the worksheet components. In this case, event registration needs to be performed for each cell. However, the registration of many events would take up a large amount of the browser's memory, resulting in a slow page loading speed. In addition, each time it enters data in the worksheet, the browser needs to do page rendering for every cell, which takes a long time, thus leading to a low efficiency.

### SUMMARY

It is therefore one primary object of the present application to provide a method, an apparatus, and a server for rendering a cell page, as well as a readable storage medium, which are intended to solve the technical problem with the existent cell page rendering means that it uses up a large amount of memory resulting in a slow page loading speed and that the data entry efficiency is low.

To achieve the above object, the present application provides a method for rendering a cell page, the method being applied to a server and including the following operations:

obtaining, by a server, a preset editor and a worksheet that awaits processing, wherein the worksheet including a plurality of cells;

in response to detection of a click event at a location of any one of the plurality of cells, obtaining a table attribute of this cell based on the editor; and

initializing a worksheet element for the cell based on the obtained table attribute to achieve the rendering of the cell page, wherein the worksheet element includes a text entry box, a drop-down box, a selection box, or a date selection box.

In addition, in order to achieve the above object, the present application further provides an apparatus for rendering a cell page, the apparatus including:

an acquisition module configured to obtain a preset editor and a worksheet that awaits processing, wherein the worksheet including a plurality of cells;

wherein the acquisition module is further configured to, in response to detection of a click event at a location of any one of the plurality of cells, obtain a table attribute of this cell based on the editor; and

an initialization module configured to initialize a worksheet element for the cell based on the obtained table attribute to achieve the rendering of the cell page, wherein the worksheet element includes a text entry box, a drop-down box, a selection box, or a date selection box.

Further, in order to the above object, this application further provides a server, which includes a memory, a processor, and a cell page rendering program that is stored in the memory and that is operable on the processor, the cell page rendering program when executed by the processor performing the operations of the above-described method for rendering a cell page.

Still further, in order to the above object, the present application further provides a readable storage medium in which a cell page rendering program is stored, the cell page rendering program when executed by a processor performing the operations of the above-described method for rendering a cell page.

According to the technical solutions proposed by this application, the server first obtains a preset editor and a worksheet to be processed. Then when a click event is detected at a position of any cell, the editor is based on to acquire a table attribute of this cell. Then based on the acquired table attribute, a worksheet element is initialized for this cell, thus achieving the purpose of rendering the cell page. Thus, data can later be entered to the cell. This application implements the rendering of the cell page in the server, and uses the editor to perform the page rendering. Because there is no need to bind each and every cell to the worksheet components, the parallel occurrence of multiple registration events is avoided and so the page loading speed is improved. In addition, only when a click event is detected will the page rendering be performed on the clicked cell using the editor, rather than having to load all the cells each time, thereby improving the page rendering efficiency.

### BRIEF DESCRIPTION OF THE ACCOMPANYING DRAWINGS

FIG. 1 is a schematic diagram illustrating the structure of a server in terms of hardware operating environment involved in the solutions embodied in the embodiments according to the present application.

FIG. 2 is an illustrative flowchart of a first embodiment of a method for rendering a cell page according to the present application.

FIG. 3 is an illustrative flowchart of a second embodiment of a method for rendering a cell page according to the present application.

FIG. 4 is an illustrative flowchart of a third embodiment of a method for rendering a cell page according to the present application.

Various implementations, functional features, and advantages of this application will now be described in further detail in connection with embodiments and the accompanying drawings.

### DETAILED DESCRIPTION OF ILLUSTRATIVE EMBODIMENTS

It will be appreciated that the embodiments described herein are merely illustrative of the present application and are not intended to limit the application.

It will be appreciated that in an existing loss details page of an insurance claim, there exists a large amount of data editing, where if the conventional page rendering method is employed, it would result in a reduced efficiency and increased memory consumption.

Therefore, in order to improve the page loading speed, reduce the browser's memory consumption, and improve the page rendering efficiency, the present application proposes a method of rendering a cell page. In the embodiments according to this application, the native worksheet components are canceled in the details worksheet, and an editor is used as a proxy for data entry. Thus, by using the editor to perform the rendering of the worksheet elements for the cells, there is no need to bind every cell to the native worksheet components. Instead, when entering data in the cells, it is only needed to perform rendering of each cell using the editor. That is, the editor can display a corresponding type of interface box in the cell according to the table attribute of this cell, such as a text entry box, a drop-down box, a selection box, a date selection box, and so on, thereby realizing data entry. This avoids the browser memory consumption thus improving the page loading speed, leading to improved performance. In addition, each time the page is rendered, it is only needed to render the cell where the editor is currently located, which improves the page rendering efficiency.

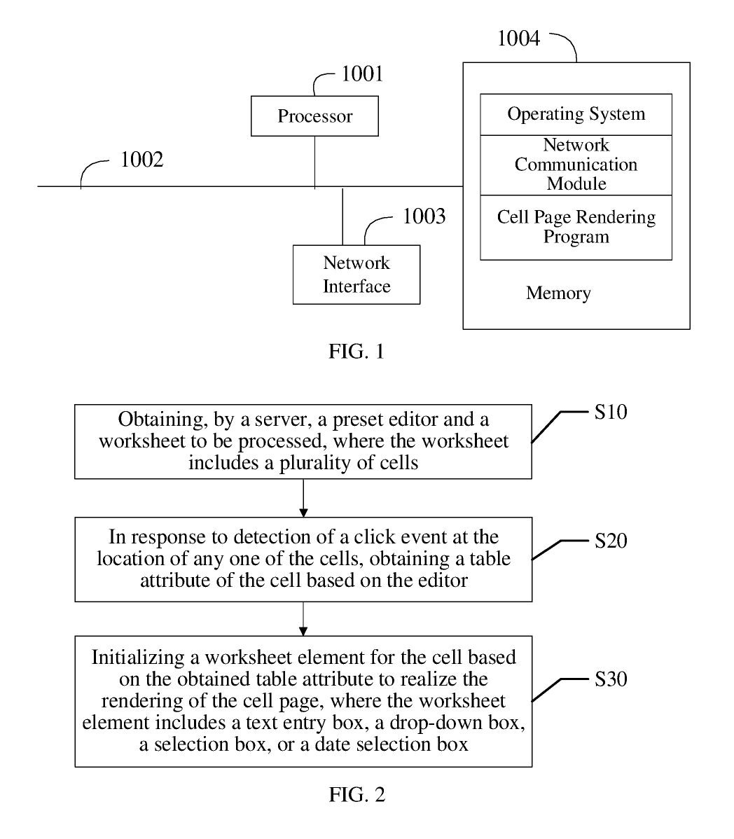

FIG. 1 is a schematic diagram illustrating the structure of a server in terms of hardware operating environment involved in the solutions embodied in the embodiments according to the present application.

In this embodiment of the present application, the server includes without limitation a one-way server, a multi-way server, and a distributed server.

As illustrated in FIG. 1, the server may include a processor 1001 (such as a CPU), a communication bus 1002, a network interface 1003, and a memory 1004. The communication bus 1002 is configured to facilitate connection and communication between these components. The network interface 1003 may optionally include a standard wired interface (for connecting to a wired network), and a wireless interface (such as a WI-FI interface, a Bluetooth interface, an infrared interface, a probe interface, a 3G/4G/5G network communication interface, etc., for connecting to a wireless network). The memory 1004 may be a high-speed RAM memory, or a non-volatile memory such as a disk memory. The memory 1004 optionally may also be a storage device that is separate from the processor 1001 described above.

Those skilled in the art can understand that the structure of the server illustrated in FIG. 1 does not constitute a limitation on the server. Thus, the server may include more or less components than those illustrated, or some components may be combined, or different arrangements of components may be employed.

As illustrated in FIG. 1, the memory 1004 as a readable storage medium may include an operating system, a network communication module, and a cell page rendering program. The operating system is a program that manages and controls server and software resources. It supports the operations of the network communication module, the cell page rendering program, and other programs or software. The network communication module is used to manage and control the network interface 1003.

In the server as illustrated in FIG. 1, the network interface 1003 is primarily used to connect to a front-end page for data communication with the front-end page. The server invokes the cell page rendering program stored in the memory 1004 by the processor 1001, so as to perform the operations of the method for rendering a cell page.

Based on the hardware structure of the server described above, various embodiments of the method for rendering a cell page are proposed.

Referring now to FIG. 2, there is shown an illustrative flowchart of a first embodiment of a method for rendering a cell page according to the present application.

In this embodiment, the method for rendering a cell page (hereinafter interchangeably referred to as a cell page rendering method) is applied to a server. The method includes the following operations.

The server acquires a preset editor and a worksheet to be processed, where the worksheet includes a plurality of cells. When a click event is detected at the location of any one of the cells, a table attribute of the cell is obtained based on the editor. Then a worksheet element is initialized for this cell based on the obtained table attribute, thereby realizing the rendering of the cell page, where the worksheet element includes a text entry box, a drop-down box, a selection box, or a date selection box.

In this embodiment, the cell page rendering method is applied to a server, such as the server illustrated in FIG. 1. The editor is used to perform page rendering for the various cells in the worksheet. The specific form of the editor is not limited; it may be displayed on a cell as a rectangle or as other shapes. The worksheet refers to a table that includes row and column identifiers, as illustrated in Table 1:

TABLE 1

| | | | |
|---|---|---|---|
| Name | Number | Gender | Age |

The name, the number, the gender, and the age denote the row and column identifiers of the worksheet. As can be seen from Table 1, the identifiers included in the worksheet are all column identifiers. Of course, a worksheet including row identifiers may also be obtained according to actual needs, which however is not to be detailed herein. The cells in the worksheet are the various blanks or boxes shown in Table 1.

The specific steps of implementing the rendering of the cell page according to this embodiment are as follows.

In step S10, the method includes: obtaining, by a server, a preset editor and a worksheet that awaits processing, wherein the worksheet including a plurality of cells.

In this embodiment, the server may start a single thread in advance, so that the editor and the worksheet to be processed are acquired in succession by the single thread started, where the order in which the editor and the worksheet are acquired will not be limited herein. For example, the editor may be acquired first before the worksheet is acquired, or the worksheet may be acquire earlier before the editor is then acquired.

Further, in order to improve the efficiency of rendering the cell page, the server may also start a dual-thread in advance to obtain the editor and the worksheet simultaneously through the two threads. In various embodiments of this application, the editor and the worksheet can be exemplarily obtained in a dual-threaded manner.

In this embodiment, the step of the server acquiring the preset editor includes the following steps a and b.

In step a, the server adds an editor worksheet panel in an initialization entry of the editor.

In step b, an event proxy is called to process the editor worksheet panel, so as to initialize the editor and obtain the editor.

That is, the server first adds an editor worksheet panel to the editor's initialization entry, and after the editor worksheet panel is successfully added, call the event proxy to process the editor worksheet panel, thus realizing the initialization process of the editor to get the editor, and then the editor is obtained.

It should be noted that the initialization process of the editor may be performed by the server in advance and stored in the corresponding storage space, and so can subsequently be acquired from the storage space. Of course, the editor can also be initialized only when it is needed, and so the editor can be acquired after the initialization is complete.

In this embodiment, the step of the server acquiring the worksheet to be processed includes the following steps c to e.

In step c, the server obtains an empty table, and further obtains row and column identifiers to be added to the empty table.

In step d, the locations for placement of the row and column identifiers in the empty table are determined based on a pre-stored service data table.

In step e, the row and column identifier are added to the empty table according to the determined placement locations, so as to obtain the worksheet.

That is, the server first acquires an empty table, which may be a table the server stores in advance in the database, or may also be a table currently established by the server. After it obtains the empty table, the server would then retrieve from the database the row and column identifiers that are to be added to the empty table, where the row and column identifiers described herein are the column identifiers, such as the name, the number, gender, and age, as exemplified in the above Table 1. After obtaining the row and column identifiers of the cells, the server may then extract a pre-stored service data table, and further determine the locations for placement of the row and column identifiers in the empty table by means of looking up the table. Then after the placement locations are determined, the row and column identifiers can be added to the empty table according to the determined placement locations, so as to obtain the worksheet.

For a better understanding of this embodiment, an example is raised as follows.

Initially, the server obtains an empty table, which is as follows:

TABLE 2

If at this point the row and column identifiers retrieved from the database include a name, a number, a gender, an age, etc., and after querying the service data table the placement locations of the various row and column identifiers in the empty table are detected as all landed in the first row and arranged in their respective columns in order from front to back, then the following worksheet can be obtained through the above processing:

TABLE 3

| | | | |
|---|---|---|---|
| Name | Number | Gender | Age |

Through the above process, the editor and the worksheet to be processed can be obtained.

In S20, the method includes: in response to detection of a click event at a location of any one of the plurality of cells, obtaining a table attribute of this cell based on the editor.

After the editor and the worksheet are obtained, if a click event is detected at the location of any cell of the worksheet, then the table attribute of this cell can be obtained based on the editor. The click event may be a click event input by a user based on a mouse, or may also be a click event input by the user based on a finger touch operation.

Specifically, step S20 includes the following steps f and g.

In step f, when a click event is detected at the location of any cell, a determination is performed as to whether this cell is activated.

In step g, if the cell is not activated, the following step is performed: obtaining the table attribute of the cell based on the editor, where the cell is activated after a worksheet element is initialized for the cell.

That is, in this embodiment, when it detects a click event at the location of any cell, the server would first detect whether this cell is activated, where the cell would be activated after a worksheet element is initialized for the cell.

In other words, when the click event is detected in the cell this time, it is first determined whether the cell is clicked for the first time. If the cell is clicked for the first time, then it indicates this cell has not been initialized by the editor, namely the cell has not been activated. In this case, the table attribute of this cell would be obtained based on the editor. If this cell has currently been activated, then it indicates that the cell has been clicked before, and the editor has already performed page rendering for this cell. In this case, the editor would no longer perform the operation of obtaining the table attribute of this cell, while data can be directly entered in the editor of this cell.

In this embodiment, the table attribute of a cell refers to the attribute information of the row or column where this cell is located. The table attribute of a cell is determined based on the row identifier of the row where the cell is located or on the column identifier of the column where the cell is located. For example, the worksheet is as illustrated in the foregoing Table 1, and the cell corresponding to the click event is located in the column “Name”, then it indicates the corresponding column identifier of this cell is “Name”, and so the table attribute of this cell is “Name”.

Further, the following operations are performed simultaneously while performing the step S20:

determining the position, width, and height of the cell; and

adjusting the position, the width, and the height of the editor based on the determined position, width, and height, so as to hover the adjusted editor above the cell.

In other words, after having obtained the table attribute of the cell based on the editor, the server would determine the position, the width, and the height of this cell, and then adjust the position as well as the width and height of the cell based on the position, the width and the height of the cell, in order that the adjusted editor is located above the cell and is the same size as the cell. Later on, the adjusted editor can be suspended above the cell, to facilitate data entry in the editor.

In S30, the method includes initializing a worksheet element for the cell based on the obtained table attribute to achieve the rendering of the cell page, wherein the worksheet element includes a text entry box, a drop-down box, a selection box, or a date selection box.

In this embodiment, after obtaining the table attribute, the corresponding worksheet elements of this cell can be determined based on the preset mapping relationships between the table attributes and the worksheet elements.

The mapping relationships between the table attributes and the worksheet elements are stored in advance. In this embodiment, the mapping relationships are not limited to one-to-one or one-to-multiple. That is, the same table attribute may correspond to one or more worksheet elements. For example, when the table attribute is Age, then the worksheet elements corresponding to this table attribute can be one of the text entry box and the drop-down box, or may also be the two of the above.

When the mapping relationships between the table attributes and the worksheet elements are one-to-multiple, then the multiple worksheet elements may be prioritized. Then the corresponding worksheet elements can be displayed in the cell according to the priority order. For example, the worksheet elements of the cell include a text entry box and a drop-down box, where the priorities of these two worksheet elements are the drop-down box, and the text entry box in order, then subsequently the worksheet element that is displayed first would be the drop-down box. Later in using the cell, the worksheet element displayed in the cell can be switched by a double-click operation. For example, after double-clicking, the text entry box would be displayed in the cell.

After determining the corresponding worksheet elements of the cell, the server would then initialize the cell so that the cell displays the worksheet elements, thus fulfilling the rendering of the cell page.

According to the technical solutions proposed by this embodiment, the server first obtains a preset editor and a worksheet to be processed. Then when a click event is detected at a position of any cell, the editor is based on to acquire a table attribute of this cell. Then based on the acquired table attribute, a worksheet element is initialized for this cell, thus achieving the purpose of rendering the cell page. Thus, data can later be entered to the cell. This application implements the rendering of the cell page in the server, and uses the editor to perform the page rendering. Because there is no need to bind each and every cell to the worksheet components, the parallel occurrence of multiple registration events is avoided and so the page loading speed is improved. In addition, only when a click event is detected will the page rendering be performed on the clicked cell using the editor, rather than having to load all the cells each time, thereby improving the page rendering efficiency.

Further, a second embodiment of the cell page rendering method according to this application is proposed on the basis of the first embodiment.

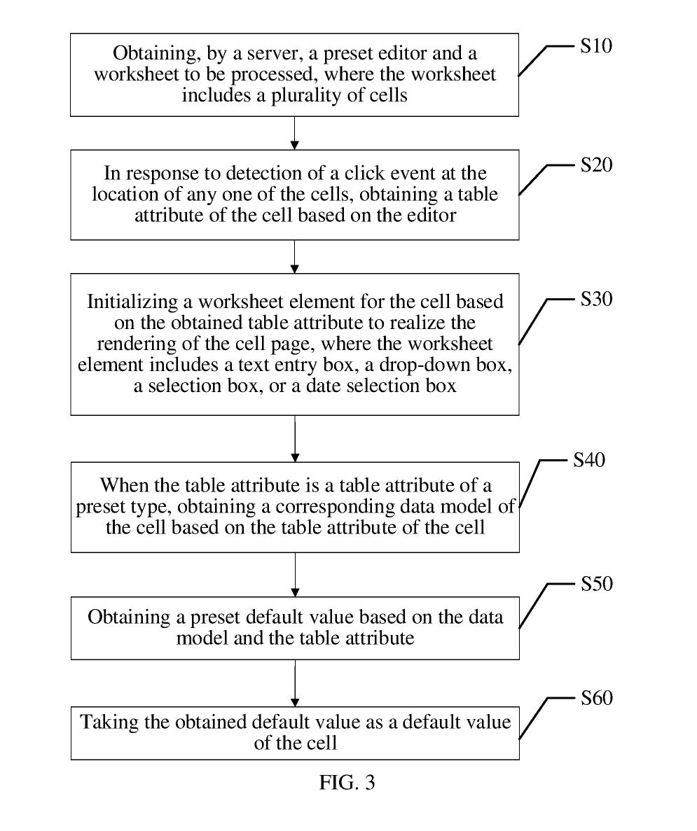

The second embodiment of the cell page rendering method differs from the first embodiment of the cell page rendering method in that, the method further includes the following steps S40 to S60 subsequent to the step S30, as illustrated in FIG. 3.

In S40, when the table attribute is a table attribute of a preset type, a corresponding data model of the cell is obtained based on the table attribute of this cell.

In S50, a preset default value is obtained based on the data model and the table attribute.

In S60, the obtained default value is taken as the default value of the cell.

In this embodiment, after performing page rendering for the cell, the table attribute of each cell is determined. In this embodiment, the table attribute of the preset type includes the corresponding table attributes of the gender, the age, and the number. When the table attribute is the gender, the age, and the number, the corresponding data model of the cell is obtained based on the table attribute of the cell. The data model includes text, number, etc. After the corresponding data model of the cell is obtained, the preset default values are obtained based on the data model and the table attribute.

For example, if the table attribute is gender, then the corresponding default values of this table attribute are “male” and “female”. As such, the default values of the cell are initialized based on the default values “male” and “female”, so that the cell has the default values “male” and “female”. If the table attribute is age, then the corresponding default values of this table attribute may be set to 1-100. As such, the default values of the cell can be initialized based on the default values 1-100, so that the cell would have the default values 1-100.

After the default values are set for the cell, the appropriate data can be entered in the editor so as to realize the data entry in the cell.

In this embodiment, after the cell is rendered, the default values are initialized in the cell, so that when subsequently entering data, the default values can be selected from, thus improving the convenience of data entry.

Further, a third embodiment of the cell page rendering method according to this application is proposed on the basis of the second embodiment.

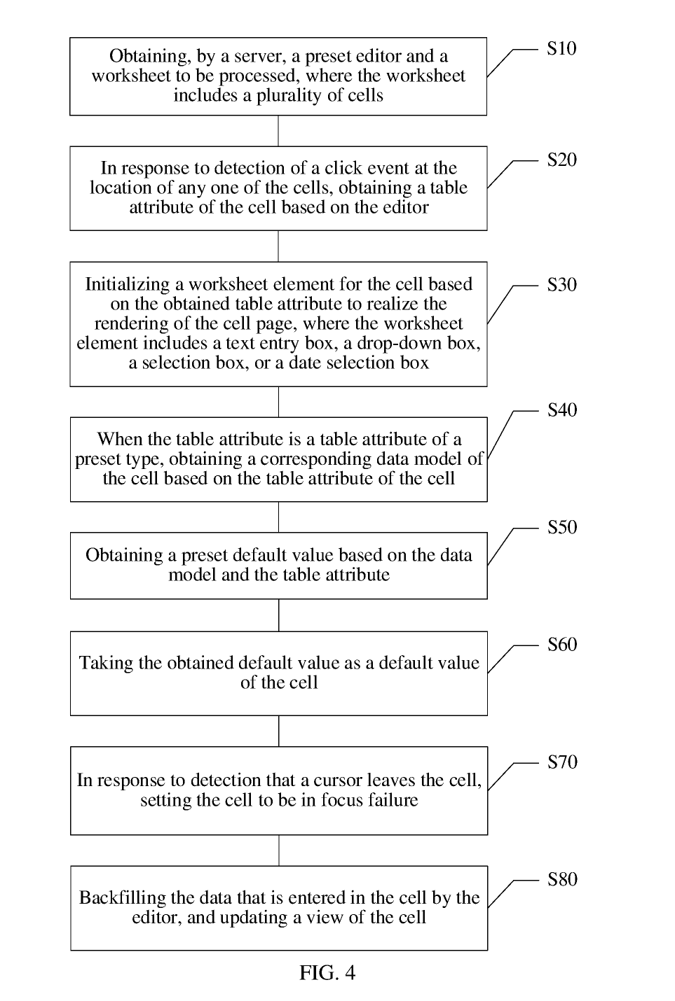

The third embodiment of the cell page rendering method differs from the second embodiment of the cell page rendering method in that, the method further includes the following steps S70 to S80 subsequent to the step S60, as illustrated in FIG. 4.

In S70, in response to detection that the cursor leaves the cell, the cell is set to be focus invalid.

In S80, the data entered in the cell by the editor is backfilled, and the view of the cell is updated.

In this embodiment, when detecting that the cursor leaves the cell, it is equivalent to the cursor currently not clicking the cell, then the cell would be set to be focus invalid, and the data entered in the cell by the editor would be backfilled. That is, the data entered is validated to save the entered data into the cell.

In addition, after the data backfill, the server updates the view of the cell; that is, the view of the cell in which the editor is originally displayed is updated, so that the view in the cell has only the cell and the entered data, where the editor is no longer displayed.

In this embodiment, when detecting that the cursor leaves the cell, the data in the cell is backfilled and the view of this cell is updated, thus fulfilling the page refresh of the table by simply updating the view layer without needing to be concerned about the worksheet elements. Therefore, the page rendering speed is improved.

Further, a fourth embodiment of the cell page rendering method according to this application is proposed on the basis of the first through the third embodiments.

The fourth embodiment of the cell page rendering method differs from the first through third embodiments of the cell page rendering method in that the editor is hidden when no click event is received in the worksheet.

That is, in this embodiment of the application, the editor in the worksheet is displayed only when a click event is received at the location of a cell. If no click event is received in the cells, then the editor will be hidden, which will not affect viewing the data in the worksheet, making the page rendering means more flexible and intelligent.

In addition, the cell page rendering method further includes the following operation:

declaring a method of initializing the editor to add new functionality to the editor.

Specifically, after adding the editor worksheet panel to the initialization entry of the editor, new functions can be added to the worksheet panel. Then an event proxy is called to process this editor worksheet panel so as to initialize this editor.

That is, in this embodiment of the application, the functions of the editor can be added according to actual needs, so that the functions of the editor can be even richer.

The present disclosure further provides an apparatus for rendering a cell page (hereinafter interchangeably referred to as a cell page rendering apparatus).

A first embodiment of the cell page rendering apparatus according to this disclosure is presented as follows.

This embodiment provides a cell page rendering apparatus, which is applied to a server and includes:

an acquisition module configured to obtain a preset editor and a worksheet that awaits processing, wherein the worksheet including a plurality of cells;

wherein the acquisition module is further configured to, in response to detection of a click event at a location of any one of the plurality of cells, obtain a table attribute of this cell based on the editor; and

an initialization module configured to initialize a worksheet element for the cell based on the obtained table attribute to achieve the rendering of the cell page, wherein the worksheet element includes a text entry box, a drop-down box, a selection box, or a date selection box.

In this embodiment, the cell page rendering apparatus is applied to a server, such as the server illustrated in FIG. 1. The editor is used to perform page rendering for the various cells in the worksheet. The specific form of the editor is not limited; it may be displayed on a cell as a rectangle or as other shapes. The worksheet refers to a table that includes row and column identifiers, as illustrated in Table 1:

TABLE 4

| | | | |
|---|---|---|---|
| Name | Number | Gender | Age |

The name, the number, the gender, and the age denote the row and column identifiers of the worksheet. As can be seen from Table 1, the identifiers included in the worksheet are all column identifiers. Of course, a worksheet including row identifiers may also be obtained according to actual needs, which however is not to be detailed herein. The cells in the worksheet are the various blanks or boxes shown in Table 1.

In this embodiment, the server may start a single thread in advance, so that the editor and the worksheet to be processed are acquired in succession by the single thread started, where the order in which the editor and the worksheet are acquired will not be limited herein. For example, the editor may be acquired first before the worksheet is acquired, or the worksheet may be acquire earlier before the editor is then acquired.

Further, in order to improve the efficiency of rendering the cell page, the server may also start a dual-thread in advance to obtain the editor and the worksheet simultaneously through the two threads. In various embodiments of this application, the editor and the worksheet can be exemplarily obtained in a dual-threaded manner.

In this embodiment, the acquisition module includes:

a first adding unit configured to add an editor worksheet panel in an initialization entry of the editor;

a calling unit configured to call an event proxy to process the editor worksheet panel, so as to initialize the editor and obtain the editor.

That is, the server first adds an editor worksheet panel to the editor's initialization entry, and after the editor worksheet panel is successfully added, call the event proxy to process the editor worksheet panel, thus realizing the initialization process of the editor to get the editor, and then the editor is obtained.

It should be noted that the initialization process of the editor may be performed by the server in advance and stored in the corresponding storage space, and so can subsequently be acquired from the storage space. Of course, the editor can also be initialized only when it is needed, and so the editor can be acquired after the initialization is complete.

In this embodiment, the acquisition module further includes:

an acquisition unit configured to obtain an empty table, and further obtain row and column identifiers to be added to the empty table;

a first determination unit configured to determine the locations for placement of the row and column identifiers in the empty table based on a pre-stored service data table; and

a second adding unit configured to add the row and column identifier to the empty table according to the determined placement locations, so as to obtain the worksheet.

That is, the server first acquires an empty table, which may be a table the server stores in advance in the database, or may also be a table currently established by the server. After it obtains the empty table, the server would then retrieve from the database the row and column identifiers that are to be added to the empty table, where the row and column identifiers described herein are the column identifiers, such as the name, the number, gender, and age, as exemplified in the above Table 1. After obtaining the row and column identifiers of the cells, the server may then extract a pre-stored service data table, and further determine the locations for placement of the row and column identifiers in the empty table by means of looking up the table. Then after the placement locations are determined, the row and column identifiers can be added to the empty table according to the determined placement locations, so as to obtain the worksheet.

For a better understanding of this embodiment, an example is raised as follows.

Initially, the server obtains an empty table, which is as follows:

TABLE 5

If at this point the row and column identifiers retrieved from the database include a name, a number, a gender, an age, etc., and after querying the service data table the placement locations of the various row and column identifiers in the empty table are detected as all landed in the first row and arranged in their respective columns in order from front to back, then the following worksheet can be obtained through the above processing:

TABLE 6

| | | | |
|---|---|---|---|
| Name | Number | Gender | Age |

Through the above process, the editor and the worksheet to be processed can be obtained.

After the editor and the worksheet are obtained, if a click event is detected at the location of any cell of the worksheet, then the table attribute of this cell can be obtained based on the editor. The click event may be a click event input by a user based on a mouse, or may also be a click event input by the user based on a finger touch operation. Specifically, the acquisition module further includes:

a second determination unit configured to, in response to detection of a click event at the location of any cell, determine whether this cell is activated; and

an execution unit configured to, if the cell is not activated, perform the following operation: obtaining the table attribute of the cell based on the editor, where the cell is activated after a worksheet element is initialized for the cell.

That is, in this embodiment, when it detects a click event at the location of any cell, the server would first detect whether this cell is activated, where the cell would be activated after a worksheet element is initialized for the cell.

In other words, when the click event is detected in the cell this time, it is first determined whether the cell is clicked for the first time. If the cell is clicked for the first time, then it indicates this cell has not been initialized by the editor, namely the cell has not been activated. In this case, the table attribute of this cell would be obtained based on the editor. If this cell has currently been activated, then it indicates that the cell has been clicked before, and the editor has already performed page rendering for this cell. In this case, the editor would no longer perform the operation of obtaining the table attribute of this cell, while data can be directly entered in the editor of this cell.

In this embodiment, the table attribute of a cell refers to the attribute information of the row or column where this cell is located. The table attribute of a cell is determined based on the row identifier of the row where the cell is located or on the column identifier of the column where the cell is located. For example, the worksheet is as illustrated in the foregoing Table 1, and the cell corresponding to the click event is located in the column “Name”, then it indicates the corresponding column identifier of this cell is “Name”, and so the table attribute of this cell is “Name”.

Further, the apparatus further includes:

a determination module configured to determine the position, width, and height of the cell; and

an adjustment module configured to adjust the position, the width, and the height of the editor based on the determined position, width, and height, so as to hover the adjusted editor above the cell.

In other words, after having obtained the table attribute of the cell based on the editor, the server would determine the position, the width, and the height of this cell, and then adjust the position as well as the width and height of the cell based on the position, the width and the height of the cell, in order that the adjusted editor is located above the cell and is the same size as the cell. Later on, the adjusted editor can be suspended above the cell, to facilitate data entry in the editor.

In this embodiment, after obtaining the table attribute, the corresponding worksheet elements of this cell can be determined based on the preset mapping relationships between the table attributes and the worksheet elements.

The mapping relationships between the table attributes and the worksheet elements are stored in advance. In this embodiment, the mapping relationships are not limited to one-to-one or one-to-multiple. That is, the same table attribute may correspond to one or more worksheet elements. For example, when the table attribute is Age, then the worksheet elements corresponding to this table attribute can be one of the text entry box and the drop-down box, or may also be the two of the above.

When the mapping relationships between the table attributes and the worksheet elements are one-to-multiple, then the multiple worksheet elements may be prioritized. Then the corresponding worksheet elements can be displayed in the cell according to the priority order. For example, the worksheet elements of the cell include a text entry box and a drop-down box, where the priorities of these two worksheet elements are the drop-down box, and the text entry box in order, then subsequently the worksheet element that is displayed first would be the drop-down box. Later in using the cell, the worksheet element displayed in the cell can be switched by a double-click operation. For example, after double-clicking, the text entry box would be displayed in the cell.

After determining the corresponding worksheet elements of the cell, the server would then initialize the cell so that the cell displays the worksheet elements, thus fulfilling the rendering of the cell page.

According to the technical solutions proposed by this embodiment, the server first obtains a preset editor and a worksheet to be processed. Then when a click event is detected at a position of any cell, the editor is based on to acquire a table attribute of this cell. Then based on the acquired table attribute, a worksheet element is initialized for this cell, thus achieving the purpose of rendering the cell page. Thus, data can later be entered to the cell. This application implements the rendering of the cell page in the server, and uses the editor to perform the page rendering. Because there is no need to bind each and every cell to the worksheet components, the parallel occurrence of multiple registration events is avoided and so the page loading speed is improved. In addition, only when a click event is detected will the page rendering be performed on the clicked cell using the editor, rather than having to load all the cells each time, thereby improving the page rendering efficiency.

Further, a second embodiment of the cell page rendering apparatus according to this application is proposed on the basis of the first embodiment.

The second embodiment of the cell page rendering apparatus differs from the first embodiment of the cell page rendering apparatus in that: the acquisition module is further configured to obtain a corresponding data model of the cell based on the table attribute of this cell when the table attribute is a table attribute of a preset type;

the acquisition module is further configured to obtain a preset default value based on the data model and the table attribute; and

the apparatus further includes a processing module configured to take the obtained default value as the default value of the cell.

In this embodiment, after performing page rendering for the cell, the table attribute of each cell is determined. In this embodiment, the table attribute of the preset type includes the corresponding table attributes of the gender, the age, and the number. When the table attribute is the gender, the age, and the number, the corresponding data model of the cell is obtained based on the table attribute of the cell. The data model includes text, number, etc. After the corresponding data model of the cell is obtained, the preset default values are obtained based on the data model and the table attribute.

For example, if the table attribute is gender, then the corresponding default values of this table attribute are “male” and “female”. As such, the default values of the cell are initialized based on the default values “male” and “female”, so that the cell has the default values “male” and “female”. If the table attribute is age, then the corresponding default values of this table attribute may be set to 1-100. As such, the default values of the cell can be initialized based on the default values 1-100, so that the cell would have the default values 1-100.

After the default values are set for the cell, the appropriate data can be entered in the editor so as to realize the data entry in the cell.

In this embodiment, after the cell is rendered, the default values are initialized in the cell, so that when subsequently entering data, the default values can be selected from, thus improving the convenience of data entry.

Further, a third embodiment of the cell page rendering apparatus according to this application is proposed on the basis of the second embodiment. The third embodiment of the cell page rendering apparatus differs from the second embodiment of the cell page rendering apparatus in that, the apparatus further includes:

a setting module configured to, in response to detection that the cursor leaves the cell, set the cell to be focus invalid; and

a backfill and update module configured to backfill the data that is entered in the cell by the editor, and update the view of the cell.

In this embodiment, when detecting that the cursor leaves the cell, it is equivalent to the cursor currently not clicking the cell, then the cell would be set to be focus invalid, and the data entered in the cell by the editor would be backfilled. That is, the data entered is validated to save the entered data into the cell.

In addition, after the data backfill, the server updates the view of the cell; that is, the view of the cell in which the editor is originally displayed is updated, so that the view in the cell has only the cell and the entered data, where the editor is no longer displayed.

In this embodiment, when detecting that the cursor leaves the cell, the data in the cell is backfilled and the view of this cell is updated, thus fulfilling the page refresh of the table by simply updating the view layer without needing to be concerned about the worksheet elements. Therefore, the page rendering speed is improved.

Further, a fourth embodiment of the cell page rendering apparatus according to this application is proposed on the basis of the first through the third embodiments. The fourth embodiment of the cell page rendering apparatus differs from the first through third embodiments of the cell page rendering apparatus in that the apparatus further includes a hiding module configured to hide the editor when no click event is received in the worksheet.

That is, in this embodiment of the application, the editor in the worksheet is displayed only when a click event is received at the location of a cell. If no click event is received in the cells, then the editor will be hidden, which will not affect viewing the data in the worksheet, making the page rendering means more flexible and intelligent.

In addition, the cell page rendering apparatus further includes:

a declaration module configured to declare a method of initializing the editor to add new functionality to the editor. Specifically, after adding the editor worksheet panel to the initialization entry of the editor, new functions can be added to the worksheet panel. Then an event proxy is called to process this editor worksheet panel so as to initialize this editor.

That is, in this embodiment of the application, the functions of the editor can be added according to actual needs, so that the functions of the editor can be even richer.

In addition, embodiments according to the present application further provide a readable storage medium in which a cell page rendering program is stored, the cell page rendering program when executed by a processor performing the above-described method for rendering a cell page.

As used herein, the terms “including,” “comprising,” or any other variants thereof are intended to encompass a non-exclusive inclusion, so that processes, methods, articles, or devices that include a series of elements will include not only those elements, but also other elements as well that haven't been explicitly listed or those elements inherent in such processes, methods, articles, or devices. In the absence of further restrictions, the element defined by the phrase “including/comprising a . . . ” will not preclude the existence of additional such elements in the processes, methods, articles, or devices that include the element.

The above numbering of embodiments according to the present application is intended for illustrative purposes only, and is not indicative of the pros and cons of these embodiments.

The foregoing description merely illustrates some exemplary embodiments of the application and therefore is not intended as limiting the patentable scope of the application. Any equivalent structural or flow transformations that are made taking advantage of the application and that are used directly or indirectly in other related technical fields shall all fall in the scope of protection of this application.

1. A method for rendering a cell page, the method being applied to a server and comprising:
obtaining, by a server, a preset editor and a worksheet to be processed, the worksheet comprising a plurality of cells;
in response to detection of a click event at the location of any one of the plurality of cells, obtaining a table attribute of the cell based on the editor; and
initializing a worksheet element for the cell based on the obtained table attribute to realize the rendering of the cell page, the worksheet element comprising a text entry box, a drop-down box, a selection box, or a date selection box.

2. The method of claim 1, wherein the block of “obtaining, by a server, a preset editor” comprises:
adding, by the server, an editor worksheet panel to an initialization entry of the editor; and
calling an event proxy to process the editor worksheet panel, to initialize the editor and obtain the editor.

3. The method of claim 1, wherein the block of “obtaining, by a server, a worksheet to be processed” comprises:
obtaining, by the server, an empty table, and obtaining row and column identifiers that to be added to the empty table;
determining the locations for placement of the row and column identifiers in the empty table based on a pre-stored service data table; and
adding the row and column identifiers to the empty table according to the determined placement locations, to obtain the worksheet.

4. The method of claim 1, wherein the block of “in response to detection of a click event at the location of any one of the plurality of cells, obtaining a table attribute of the cell based on the editor” comprises:
in response to detection of a click event at the location of any one of the plurality of cells, determining whether the cell is activated; and
if the cell is not activated, performing the operation of obtaining the table attribute of the cell based on the editor, wherein the cell is identified to have been activated after a worksheet element is initialized for the cell.

5. The method of claim 1, wherein the following operations are simultaneously performed while performing the block of “in response to detection of a click event at the location of any one of the plurality of cells, obtaining a table attribute of the cell based on the editor”:
determining a position, a width, and a height of the cell; and
adjusting the position, the width, and the height of the editor based on the determined position, width, and height, to hover the adjusted editor above the cell.

6. The method of claim 1, further comprising the following operations subsequent to the block of “initializing a worksheet element for the cell based on the obtained table attribute to realize the rendering of the cell page:
when the table attribute is a table attribute of a preset type, obtaining a corresponding data model of the cell based on the table attribute of the cell;
obtaining a preset default value based on the data model and the table attribute; and
taking the obtained default value as a default value of the cell.

7. The method of claim 1, further comprising the following operations subsequent to the block of “initializing a worksheet element for the cell based on the obtained table attribute to realize the rendering of the cell page”:
in response to detection that a cursor leaves the cell, setting the cell to be focus invalid; and
backfilling the data that is entered in the cell by the editor, and updating a view of the cell.

8. The method of claim 1, wherein the editor is hidden when no click event is received in the worksheet.

9. The method of claim 7, wherein the editor is hidden when no click event is received in the worksheet.

10. An apparatus for rendering a cell page, the apparatus being applied to a server and comprising a processor and a non-transitory memory coupled to the processor, the non-transitory memory storing programmed instruction units executable by the processor, the programmed instruction units comprising:
an acquisition module, configured to obtain a preset editor and a worksheet to be processed, the worksheet comprising a plurality of cells, the acquisition module being further configured to, in response to detection of a click event at the location of any one of the plurality of cells, obtain a table attribute of the cell based on the editor; and
an initialization module, configured to initialize a worksheet element for the cell based on the obtained table attribute to realize the rendering of the cell page, the worksheet element including a text entry box, a drop-down box, a selection box, or a date selection box.

11. The apparatus of claim 10, wherein the acquisition module comprises:
a first adding unit, configured to add an editor worksheet panel to an initialization entry of the editor; and
a calling unit, configured to call an event proxy to process the editor worksheet panel, to initialize the editor and obtain the editor.

12. The apparatus of claim 10, wherein the acquisition module further comprises:
an acquisition unit, configured to obtain an empty table, and obtain row and column identifiers that are to be added to the empty table;
a first determination unit, configured to determine the locations for placement of the row and column identifiers in the empty table based on a pre-stored service data table; and
a second adding unit, configured to add the row and column identifiers to the empty table according to the determined placement locations, to obtain the worksheet.

13. The apparatus of claim 10, wherein the acquisition module further comprises:
a second determination unit, configured to, in response to detection of a click event at the location of any one of the plurality of cells, determine whether the cell is activated; and
an execution unit configured to, if the cell is not activated, perform the following operation: obtaining the table attribute of the cell based on the editor, wherein the cell is activated after a worksheet element is initialized for the cell.

14. The apparatus of claim 10, wherein the programmed instruction units further comprise:
a determination module, configured to determine a position, a width, and a height of the cell; and
an adjustment module, configured to adjust the position, the width, and the height of the editor based on the determined position, width, and height, to hover the adjusted editor above the cell.

15. The apparatus of claim 10, wherein the acquisition module is further configured to obtain a corresponding data model of the cell based on the table attribute of the cell when the table attribute is a table attribute of a preset type;
the acquisition module is further configured to obtain a preset default value based on the data model and the table attribute; and
the programmed instruction units further comprise a processing module configured to take the obtained default value as a default value of the cell.

16. The apparatus of claim 10, wherein the programmed instruction units further comprise:
a setting module, configured to, in response to detection that a cursor leaves the cell, set the cell to be focus invalid; and
a backfill and update module, configured to backfill the data that is entered in the cell by the editor, and update a view of the cell.

17. The apparatus of claim 10, wherein the programmed instruction units further comprise a hiding module configured to hide the editor when no click event is received in the worksheet.

18. The apparatus of claim 16, wherein the programmed instruction units further comprise a hiding module configured to hide the editor when no click event is received in the worksheet.

19. A server, comprising a memory, a processor, and a cell page rendering program that is stored in the memory and that is operable on the processor, the cell page rendering program when executed by the processor performing the following operations:
obtaining, by the server, a preset editor and a worksheet to be processed, the worksheet comprising a plurality of cells;
in response to detection of a click event at the location of any one of the plurality of cells, obtaining a table attribute of the cell based on the editor; and
initializing a worksheet element for the cell based on the obtained table attribute to realize the rendering of the cell page, the worksheet element comprising a text entry box, a drop-down box, a selection box, or a date selection box.

20. (canceled)
